(19) United States
(12) Patent Application Publication
(10) Pub. No.: US 2024/0082084 A1
(43) Pub. Date: Mar. 14, 2024

(54) Wheelchair and Suspension Systems

(71) Applicant: Invacare Corporation, Elyria, OH (US)

(72) Inventor: Robert Bekoscke, Medina, OH (US)

(21) Appl. No.: 18/513,941

(22) Filed: Nov. 20, 2023

Related U.S. Application Data
(63) Continuation of application No. 17/179,466, filed on Feb. 19, 2021.
(60) Provisional application No. 62/981,265, filed on Feb. 25, 2020.

(51) Int. Cl. A61G 5/10

(52) U.S. Cl. CPC A61G 5/1078; A61G 5/1089

(57) ABSTRACT

Embodiments of a wheelchair and suspension system are provided. The suspension includes a drive assembly that is pivotably connected to a base frame at multiple locations. In one embodiment, the connection is via intermediary pivoting links or arms. Embodiments of the links or arms including rigid links, resilient links, elastic links, shocks, springs, gas cylinders and lockable gas cylinders (or combinations of the foregoing). The drive assembly can, via the pivot connections, pivot to accommodate and traverse variations and obstacles on ground surfaces.

### CROSS-REFERENCE TO RELATED APPLICATIONS

This application is a continuation of U.S. patent application Ser. No. 17/179,466, filed Feb. 19, 2021, titled “Wheelchair and Suspension Systems,” which claims priority to U.S. Provisional Patent Application Ser. No. 62/981,265, filed on Feb. 25, 2020, and all of which are hereby fully incorporated by reference.

### BACKGROUND

Wheelchairs and scooters are an important means of transportation for a significant portion of society. Whether manual or powered, these vehicles provide an important degree of independence for those they assist. However, this degree of independence can be limited if the wheelchair is required to traverse obstacles such as, for example, curbs that are commonly present at sidewalks, driveways, and other paved surface interfaces. This degree of independence can also be limited if the vehicle is required to ascend inclines or descend declines.

Most wheelchairs have front and/or rear anti-tip wheels to stabilize the chair from excessive tipping forward or backward and to ensure that the drive wheels are always in contact with the ground. The anti-tip wheels are typically much smaller than the drive wheels. In center wheel drive (CWD) wheelchairs, the front anti-tip wheels are normally ground engaging and mounted on pivot arms so the front anti-tip wheels can raise and lower when traveling over obstacles. Examples of CWD wheelchairs are shown in U.S. Pat. Nos. 7,040,429, 7,219,755, 7,066,290, 8,534,679, 8,794,359, and 8,910,975, which are hereby fully incorporated by reference.

In front wheel drive (FWD) wheelchairs, the front anti-tip wheels are typically suspended above the ground, as shown in U.S. Pat. No. 9,010,470 to Cuson et al. and hereby fully incorporated by reference. By having the front anti-tip wheels suspended above the ground, FWD wheelchairs allow the much larger front drive wheels to navigate over the obstacle without being impeded by the front anti-tip wheels.

While these configurations provide important advancements, additional improvements are desirable including better ground engagement (or traction) by drive wheels and more comfortable rides as rough terrain or obstacles are traversed.

### SUMMARY

In one embodiment, a wheelchair is provided having a suspension system. The suspension includes a drive assembly that is pivotably connected to a base frame at multiple locations. In one embodiment, the connection is via intermediary pivoting links or arms. Embodiments of the links or arms include rigid links, resilient links, elastic links, shocks, springs, gas cylinders and lockable gas cylinders (or combinations of the foregoing). The drive assembly can, via the pivot connections, pivot to accommodate and traverse variations and obstacles on ground surfaces.

### BRIEF DESCRIPTION OF THE DRAWINGS

In the accompanying drawings which are incorporated in and constitute a part of the specification, embodiments of the inventions are illustrated, which, together with a general description of the inventions above, and the detailed descriptions given below, serve to example the principles of the inventions.

FIGS. 1-4C illustrate various embodiments of a power wheelchair and suspension system.

FIGS. 5-11 illustrate various views of another embodiment of a power wheelchair and suspension system.

FIG. 12 illustrates an exploded perspective view of the suspension system embodiment shown FIGS. 5-11.

FIGS. 13 and 14 are select component views of the suspension system shown in FIG. 12.

FIG. 15-17 are various views of one embodiment of drive assembly components.

FIGS. 18-22 illustrate various views and embodiments of an ornamental design for a hub and wheel hub combination.

FIGS. 23-27 illustrate various views and embodiments of an ornamental design for a hub and wheel hub combination.

### DESCRIPTION

Embodiments of the invention provide, for example, a wheelchair suspension having the ability for drive wheels to maintain traction and comfort while traversing rough terrain or obstacles. The suspension can pivot the drive assembly about one or more pivot axes with respect to the base frame. In one embodiment, the drive assembly pivots about multiple pivot axes with respect to the drive assembly providing traction control and ride comfort over rough terrain and obstacles. The embodiments of suspension systems disclosed herein are applicable to any configuration of wheelchair or mobility vehicle including FWD, CWD and RWD (rear wheel drive).

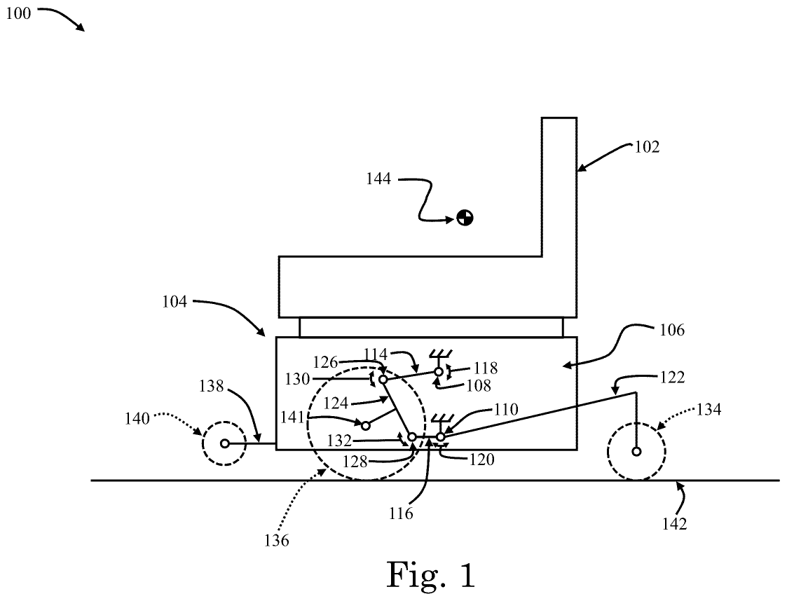

Referring now to FIGS. 1-4A, various embodiments of a power wheelchair and suspension system are shown. Only one side of the power wheelchair is illustrated with the understanding the other side is a mirror arrangement. FIG. 1 illustrates a wheelchair 100 having a seat (or seating system) 102 and a base frame 104. A suspension system 106 is shown connected to the base frame 104. The base frame 104 includes multiple pivot axes or pivot connections 108 and 110 to which the suspension system 106 is connected. In one embodiment, pivot connection 108 is an upper pivot connection and located proximate the upper portion of the base frame. Pivot connection 110 is a lower pivot connection and located proximate a lower portion of the base frame.

The precise locations of these pivot connections or axis is not critical. For example, lower pivot connection 110 can be located at or near the extreme lower edge or bottom plane of the base frame 104. In other embodiments, lower pivot connection 110 can be located some distance upward (e.g., about 1 to 6 inches) from the extreme lower edge or bottom plane of base frame 104. Similarly, upper pivot connection 108 can be located at or near the extreme upper edge or upper plane of base frame 104. In other embodiments, upper pivot connection 108 can be located some distance downward (e.g., about 1 to 6 inches) from the extreme upper edge or bottom plane of base frame 104.

Still referring to FIG. 1, the suspension system 106 includes first and second links 114 and 116. Link 114 is an upper pivoting link and connected to base frame 104 via upper pivot connection 108. So connected, link 114 can pivot about upper pivot connection 108, as schematically represented by arrows 118. Link 116 is a lower pivoting link and connected to base frame 104 via lower pivot connection 110. So connected, link 116 can pivot about lower pivot connection 110, as schematically represented by arrows 120.

Links 114 and 116 each include a body and can take the form of various shapes, components, and arrangements. In the embodiment shown, each link 114 and 116 includes a pivot connection or axes such as 126 and 128, respectively. These pivot connections are used to connect a drive assembly to the suspension system 106. The drive assembly includes a mount or mounting arrangement 124. Mount 124 is movably or pivotably connected to links 114 and 116. This connection is made via pivot connections 126 and 128. So arranged, the drive assembly is mounted to base frame 104 via at least two pivot connections or axes (e.g., 108 and 110) or via multiple pivot connections or axes (126 and 108, respectively, and 128 and 110, respectively). The drive assembly typically includes a drive system having an electric motor connected to a gearbox (or, alternatively, an electric gearless and brushless motor (e.g., a wheel hub motor)). The gearbox connects to a drive axis or shaft 141 of a main drive wheel 136.

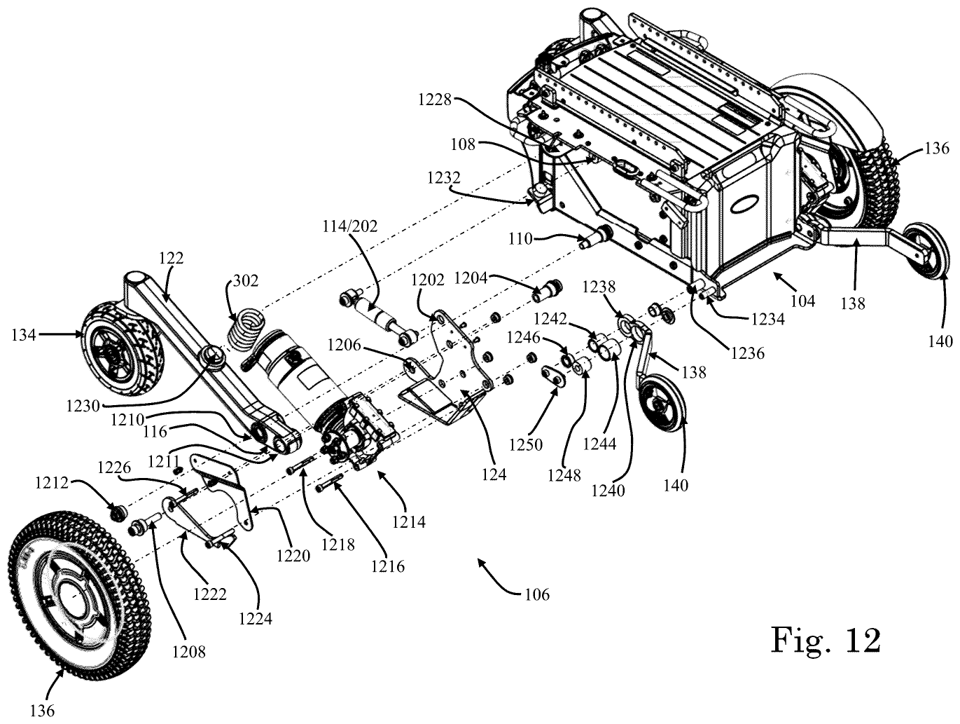

Link 116 may be an extension of or connected to another link 122 to which a rear caster wheel 134 is connected. A front wheel 140 arranged as an anti-tip wheel is connected to base frame 104 via link 138. In the embodiment shown, front anti-tip wheel 140 is suspended above the ground or normal horizontal supporting surface 142 of the wheelchair. Link 138 can be connected to base frame 104 via a rigid connection or a suspension system that can include a pivot connection or axis, which may be cushioned from impacts by a resilient member (e.g., see FIG. 12). Typically, two anti-tip wheels 140 are provided near the left and right sides of the front of base frame 104.

In the case of an FWD power wheelchair configuration, the center of gravity 144 of the wheelchair 100 and a user is generally horizontally offset very little (if any) from lower pivot connection 110 to distribute the combined load or weight between main drive wheel 136 and rear castor wheel 134. So arranged, main drive wheel 136 and rear castor wheel 134 are substantially ground engaging even over rough terrain. Horizontally offsetting center of gravity 144 from lower pivot connection 110 biases the tipping behavior of the base frame in the offset direction. The amount of biasing can be determined based on the desired base frame and suspension system behavior under weight-bearing conditions. For example, it may be desirable to slightly bias the center of gravity 144 (and base frame 104 center of gravity) rearward slightly rearward of pivot connection 110 so that anti-tip wheels 140 can more easily pivot or rotate the front portion of base frame 104 upwards when encountering a large obstacle (such as a curb or elevated sidewalk).

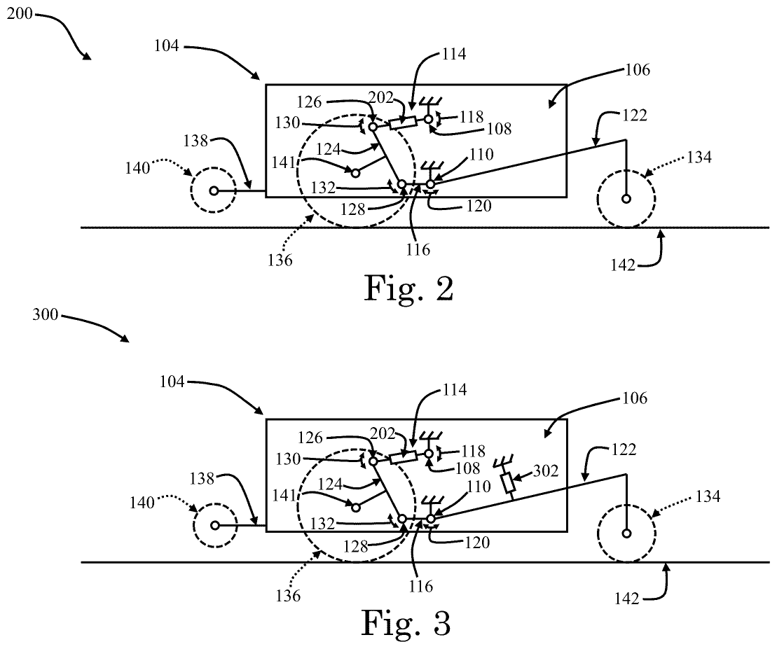

Referring now to FIG. 2, a wheelchair 200 having a suspension system similar that of FIG. 1 is shown. In FIG. 2, upper link 114 includes a resilient member 202. Resilient member 202 can take the form of various embodiments including a shock absorber, spring, spring and shock absorber, gas cylinder, lockable gas cylinder, an elastomeric body, etc., and combinations thereof. Resilient member 202 can perform various functions including, for example, absorbing impacts when drive wheel 136 encounters a large obstacle, very rough terrain, or elevated terrain. In such a situation, resilient member 202 absorbs the impact by compressing thereby not allowing the force of the impact to transfer to the base frame 104.

Resilient member 202 can also act as an extendable member allowing drive assembly 124 to pivot away from base frame 104 via pivot connection 128 and or pivot connection 110. This allows drive wheel 136 to maintain contact with variable terrain that includes terrain that may be lower than the terrain contacting the other drive wheel and/or rear caster wheels of the wheelchair. Such example includes when power wheelchair 100 is coming off an elevated surface, like an elevated sidewalk, berm and the like. Resilient member 202 can also act as a retractable member allowing drive assembly 124 to pivot into base frame 104 via pivot connection 128. This allows drive wheel 136 to maintain contact with variable terrain that includes terrain that may be higher than the terrain contacting the other drive wheel and/or rear caster wheels.

Referring now to FIG. 3, a wheelchair 300 having a suspension system similar that of FIGS. 1 and 2 is shown. In FIG. 3, suspension system 106 includes a further resilient member 302. Resilient member 302 can take the form of various embodiments including a shock absorber, spring, spring and shock absorber, gas cylinder, lockable gas cylinder, an elastomeric body, etc., and combinations thereof. Member 302 is located between base frame 104 and link 122. So arranged, member 302 can perform various functions including biasing link 122 towards the ground by distributing a portion of the wheelchair weight thereon, allowing link 122 to pivot about lower pivot connection 110 under bias pressure of the weight of base frame 104, cushioning or dampening movement (e.g., tipping) of base frame 104 against link 122, limiting movement (e.g., tipping) of base frame 104, etc. and combinations of the foregoing.

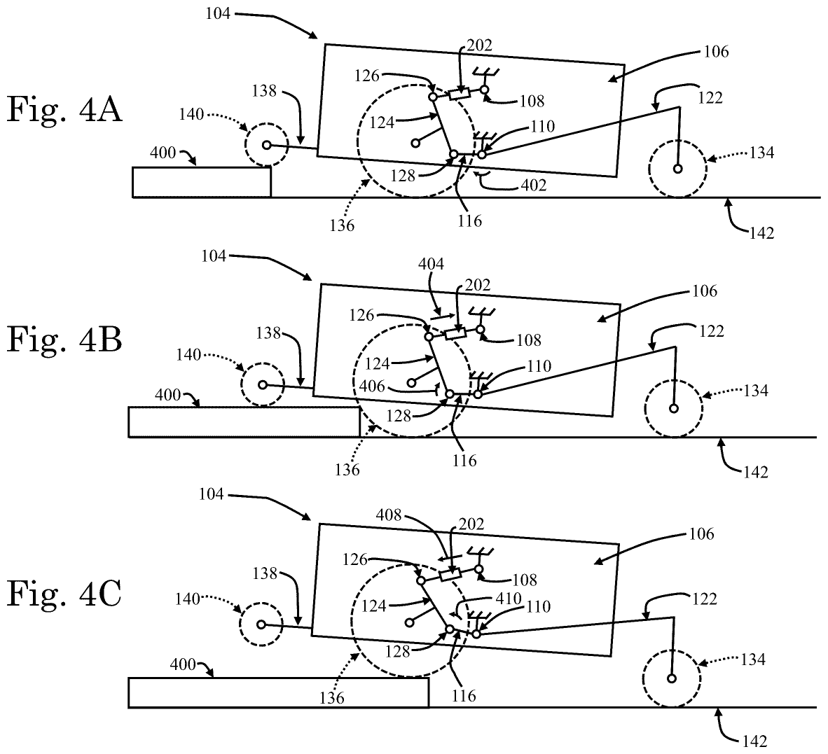

FIGS. 4A-4C illustrate the wheelchair behavior when traversing rough terrain or an obstacle such as, for example, a curb, berm, or elevated surface like a sidewalk. In FIG. 4A, the wheelchair approaches an elevated surface 400, which can be, for example, rough terrain, a large obstacle, or an elevated sidewalk. Front anti-tip wheel 140 makes initial contact with surface 400, which may be slightly cushioned if link 138 is connected to base frame 104 via a suspension having a resilient or compressible member. As the wheelchair continues to drive forward, anti-tip wheel 140 causes the front portion of base frame 104 to raise by rotating base frame 104 about lower pivot connection 110 (as indicated by arrow 402) as anti-tip wheel 140 drives itself onto the top of surface 400. Drive wheel 136 and rear castor wheel 134 maintain engagement with the lower supporting surface 142.

Referring now to FIG. 4B, as the wheelchair continues to drive forward, drive wheel 136 encounters elevated surface 400. This encounter typically creates physical impact on drive wheel 136 which may be transferred to the base frame 104 and the user. Suspension system 106 reduces the effect of this physical impact by allowing drive assembly mount 124 to pivot about pivot connection 128 (as shown by arrow 406) into base frame 104. Resilient member 202 absorbs some or all of this physical impact by compressing or retracting (as shown by arrow 404) as drive assembly mount 124 pivots against it.

Referring now to FIG. 4C, as the wheelchair continues to drive forward, drive wheel 136 is driven over and onto elevated surface 400. During this sequence, drive assembly mount 124 rotates or pivots about pivot connection 128 (as shown by arrow 410) away from base frame 104. Resilient member 202 extends or returns to its normal decompressed state (as shown by arrow 408) as drive assembly mount 124 pivots away from it. Now with drive wheel 136 on elevated surface 400, the wheelchair can continue to drive forward whereby rear castor wheel 134 will be driven over and onto elevated surface 400.

So arranged, suspension system 106 provides drive assembly mount 124 with multiple pivot connections (e.g., upper pivot connections 108 and 126 and lower pivot connections 110 and 128) to base frame 104. These pivot connections allow drive assembly mount 124 to pivot, rotate, raise, and/or lower as necessary to traverse rough terrain and obstacles while maintaining traction therewith. The inclusion of resilient member 202 allows physical impacts on drive wheel 136 to be absorbed or softened from being transferred to base frame 104 where they would be felt by a user. As previously described, less than the four illustrated pivot connections can be used and resilient member 202 may be a rigid link or other component(s). Moreover, as shown and described in connection with FIG. 3, an additional resilient member 302 can be included as part of suspension system 106.

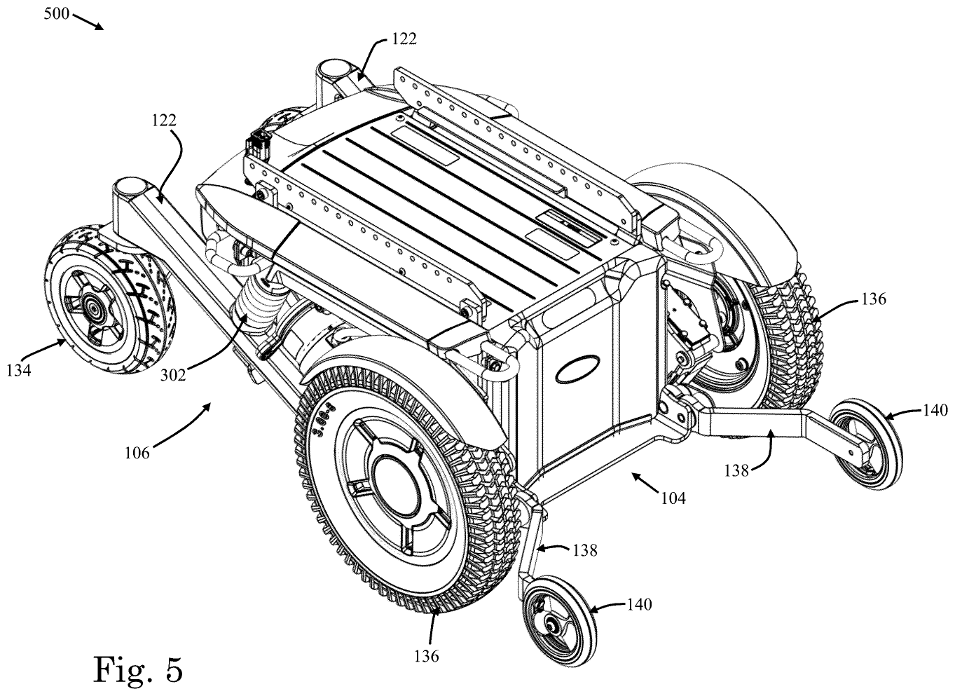

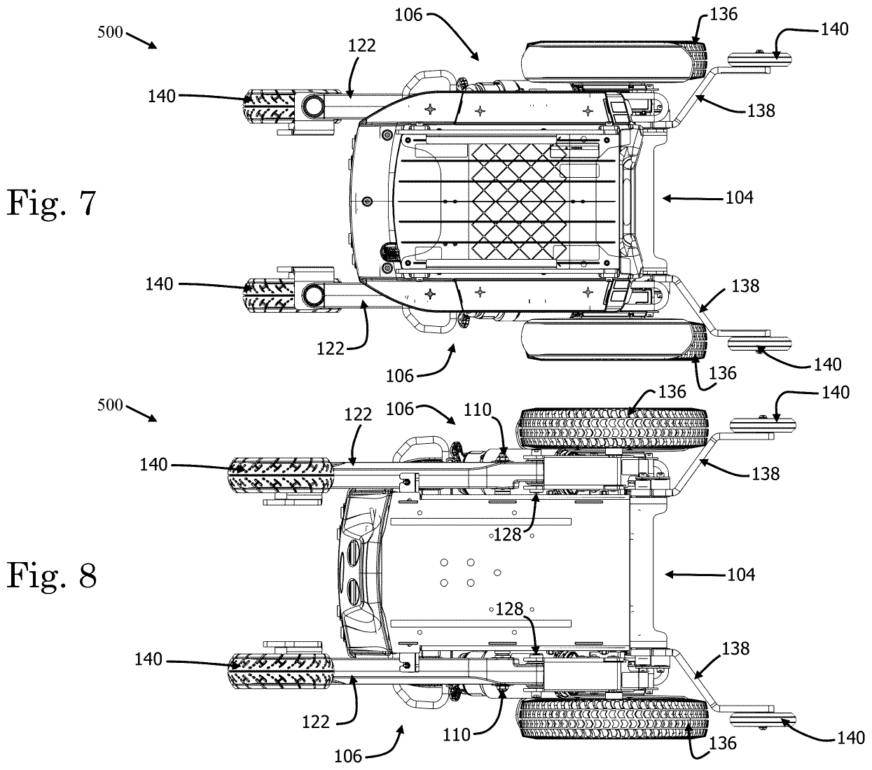

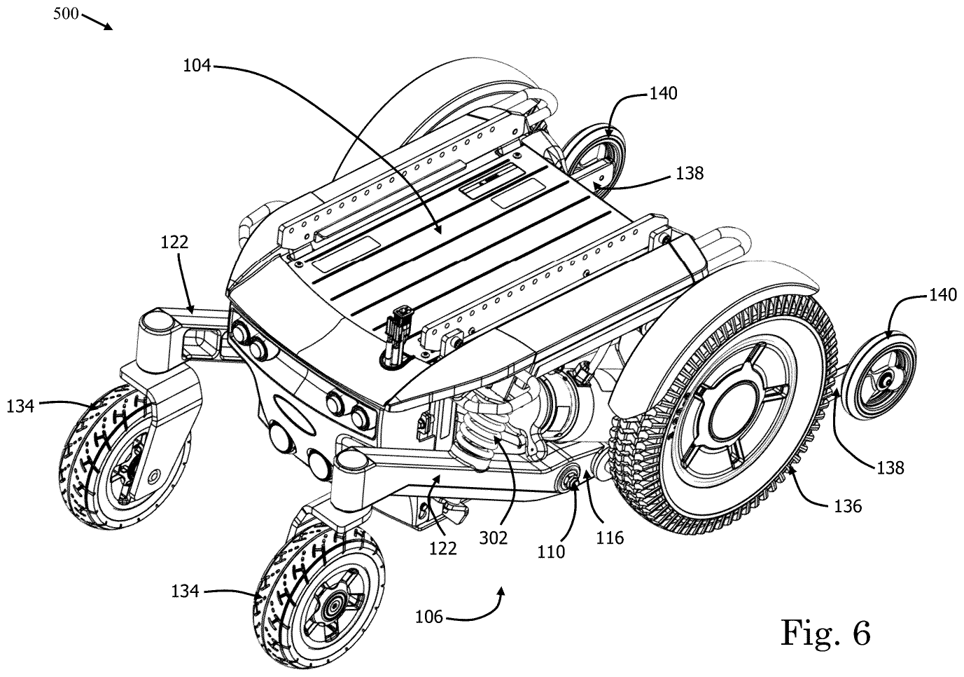

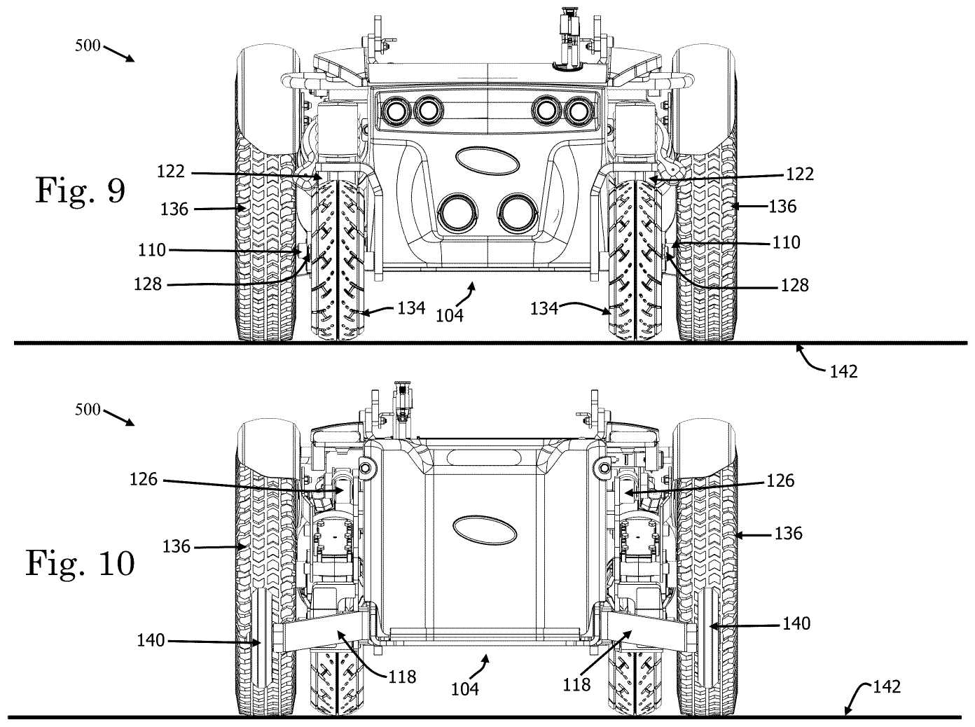

FIGS. 5-11 illustrate a more specific embodiment of a wheelchair 500 and suspension system. Wheelchair 500 is generally configured similar to the embodiments of FIGS. 1-4A previously discussed. Reference numbers from the embodiments of FIGS. 1-4A are used when referring to the same or similar general components, assemblies, and/or systems. Wheelchair 500 includes base frame 104 and suspension system 106. Left and right front anti-tip wheels 140 are connected to base frame 104 by link 138, which suspend the anti-tip wheels above the supporting surface 142 of the wheelchair (e.g., see FIGS. 7, 8, 10 and 11). Also, left and right drive wheels 136 and left and right rear castor wheels 140 are connected to base frame 140.

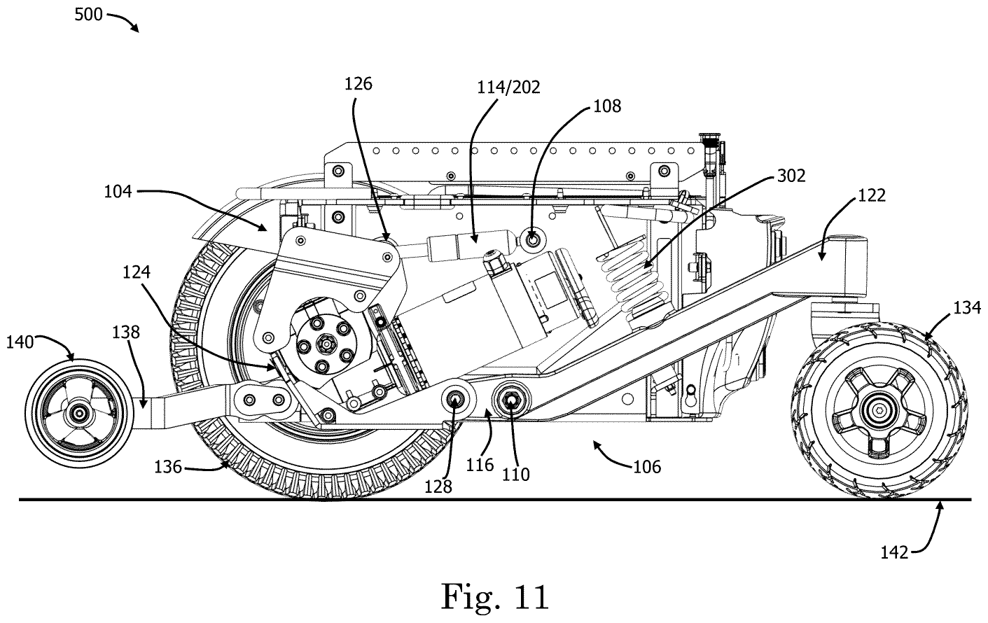

FIG. 11 shows a side elevational view with left drive wheel 136 removed for clarity. In the embodiment of wheelchair 500, upper pivot connections 108 and 126 and lower pivot connection 110 and 128 are shown. Also, link 114 is shown as resilient member 202 connecting drive assembly mount 124 to the base frame via upper pivot connections 108 and 126. Link 116 is shown connecting drive assembly mount 124 to base frame 104 via lower pivot connections 110 and 128. Wheelchair 500 further includes resilient member 302 acting between base frame 104 and link 122. Wheelchair 500 is configured as a front wheel drive (FWD) wheelchair. Wheelchair 500 via lower pivot connection 110 and resilient member 302 distribute the weight of wheelchair (and user) onto drive wheels 136 and rear castor wheels 134 so they are substantially in constant contact with the ground or terrain (i.e., drive wheels 136 and read castor wheels 134 are substantially weight-bearing). Front anti-tip wheels 140 are shown suspended above the normal horizontal supporting surface 142 of the wheelchair in order to facilitate traversing obstacles or rough terrain as exemplified by FIGS. 4A-C and the associated text.

FIG. 12 is an exploded perspective view of one side of the embodiment of wheelchair 500 showing the components of suspension system 106. Links 116 and 122 form the body of a pivot arm that is secured to pivot connection 110 via through hole 1210 and fastener 1212. Fasteners as used herein may take a plurality of forms including screws, bolts, nuts, threads, sleeves, washers, bearings, spacers, etc., and combinations of the foregoing. So joined, links 116 and 122 can pivot about pivot connection 110. Base frame 104 can also pivot about connection 110 with respect to links 116 and 122 such as, for example, when front anti-tip wheels 140 encounter a large obstacle.

Link 122 also includes a contact area 1230 for contacting one end of resilient member 302. Base frame 104 also includes a contact area 1228 for contacting the other end of resilient member 302. In this manner, resilient member 302 acts between link 122 and base frame 104. As shown, resilient member 302 is a coil spring and contact area 1230 is circular allowing the coil spring to seat or nest thereon. Contact area 1228 on base frame 104 can be similarly arranged. Base frame 104 includes a further contact area 1232 that can act as a physical stop feature limiting the amount of upward movement of the rear portion of base frame 104. Contact area 1232, which may include a resilient member, is arranged to make selective contact with the underside of link 122. Other contact area arrangements are also possible including flat or planar contact areas and those formed to seat or nest the resilient member 302.

Link 116 extends from link 122 as shown and includes through hole 1211. Through hole 1211 is used to form a lower pivot connection (i.e., pivot connection 128) between drive assembly mount 124 (including sub-mount 1222) and links 116 and 122 (e.g., forming the rear castor wheel pivot arm). Fasteners (e.g., 1204 and 1208) and mounting holes (e.g., 1206) are used in this embodiment to complete the pivot connection.

An upper pivot connection (i.e., pivot connection 126) is formed between the drive assembly mount 124 and link 114 shown as resilient member 202. One end of resilient member 202 is fastened to aperture 1202 in drive assembly mount 124. The other end of resilient member 202 is pivotably joined to base frame 104 to form a pivot connection (i.e., upper pivot connection at 108.)

A drive system 1214 can include a motor and gearbox and is joined to drive assembly mount 124. Further sub-mounts 1220 and 1222 can be included to provide additional structural support and protection to the drive system 1214. These components are collectively joined together via fasteners (e.g., 1216, 1218, 1224, and 1226).

Still referring to FIG. 12, front anti-tip wheels 140 are connected in this embodiment to base frame 104 via a suspension assembly. Suspension assembly includes link 138 having adjacent through holes 1238 and 1240. Through hole 1238 is mounted to pivot connection 1236 via fasteners 1242, 1246, and 1250. Through hole 1240 includes resilient member 1248 and receives post 1234 therein. Fasteners 1250 and 1244 secure the connection. Link 138 is permitted a range of pivotal motion (e.g., pivoting upward) around pivot connection 1236 that is limited by post 1236 acting against resilient member 1248. Resilient member 1248 can be, in one embodiment, an elastomeric cylinder receiving post 1236 therein.

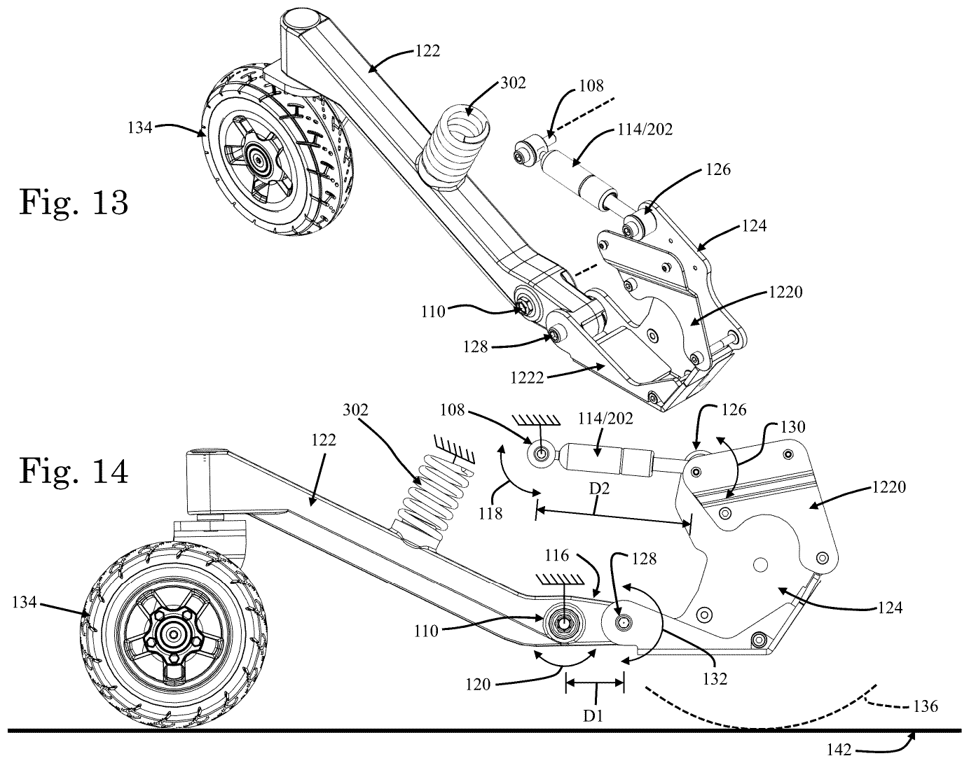

FIGS. 13 and 14 illustrate perspective and elevational views of suspension system 106 with the drive motor and gearbox components not shown. As previously described, the suspension system includes multiple pivot connections including upper pivot connections 108 and 126 and lower pivot connections 110 and 128. Upper pivot connection 108 and lower pivot connection 110 are connected to base frame 104. Upper pivot connection 108 allows link 114 (resilient member 202) to move or pivot as indicated by arrows 118. Lower pivot connection 110 allows the pivot arm formed by links 116 and 122 to move or pivot as indicated by arrows 120. Upper pivot connection 126 and lower pivot connection 128 connect links 114 and 116 to drive assembly mount 124. This allows drive assembly mount 124 to move or pivot as indicated by arrows 130 and 132.

Link 114 includes a body having first and second end portions and wherein the first end portion is connected to drive assembly mount 124 to form pivot connection 126. The second end portion of link 114 body is connected to the base frame 104 forming pivot connection 108. As shown, link 114 body may include a resilient element 202 such as, for example, a shock absorber, spring, etc. Links 116 and 122 form a pivot arm body having first and second end portions and wherein the first end portion is connected to the drive assembly mount 124 thereby forming pivot connection 128. The pivot arm body is also connected between its end portions to base frame 104 thereby forming pivot connection 110.

As previously described, resilient member 202 can extend and retract and can be a shock absorber. Resilient member 202 retracts under shock force to cushion impacts from jarring base frame 104. Resilient member 202 extends back to its normal position after the shock force has dissipated or passed. Hence, distance D2 represents the length of link 114 and can vary through this shock absorbing function. Distance D2 can also dynamically vary to accommodate changing levels of elevation or terrain to allow for continued ground engagement by drive wheels 136. In this situation, distance D2 grows and shrinks as drive wheel 136 travels over bumps, steps, and the like. Distance D1 represents the distance between lower pivot connections 110 and 128. In the embodiment shown, distance D1 is less than distance D2. The amount by which distance D1 is less than D2 can vary based on the amount of desired mechanical advantage to be applied during pivoting movement of the pivot arm.

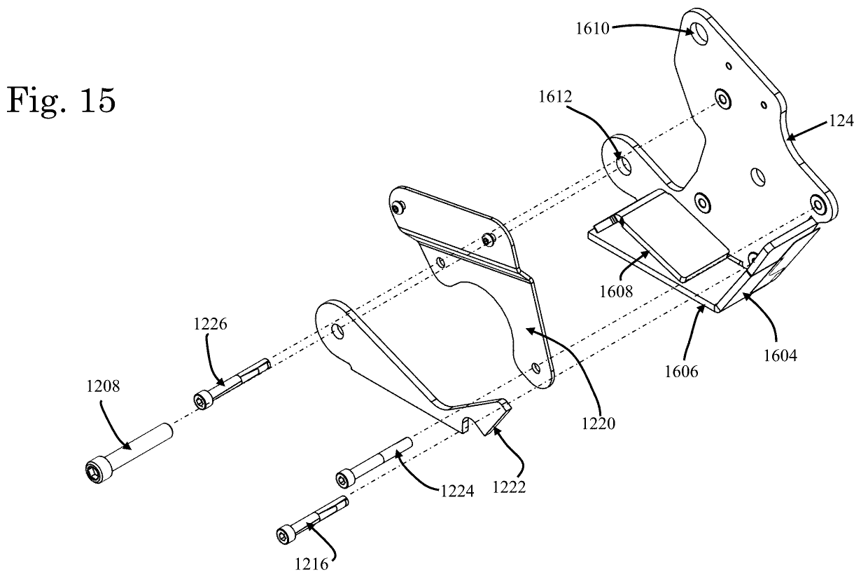

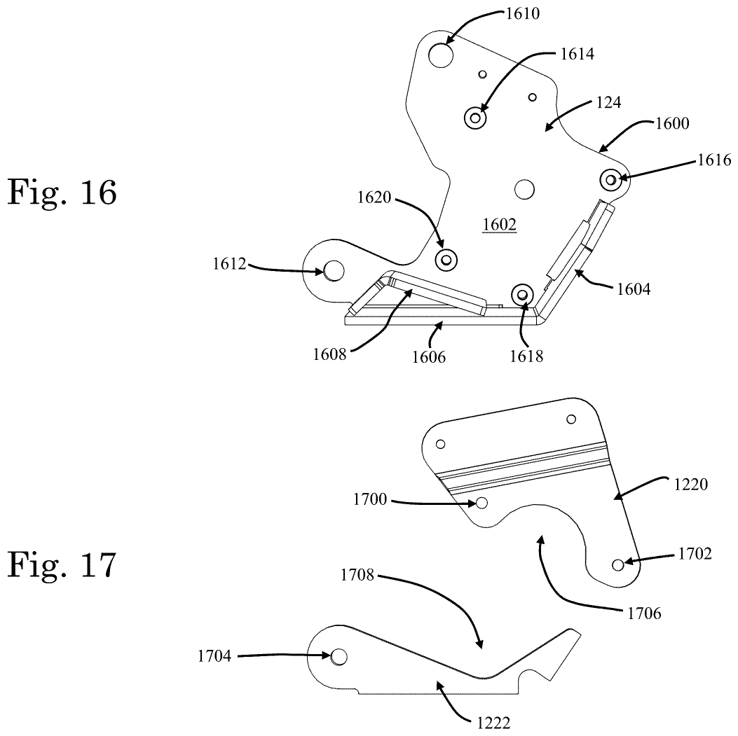

Referring now to FIGS. 15 and 16, one embodiment of a drive assembly mount 124 and optional sub-mounts 1220 and 1222 are illustrated. Drive assembly mount 124 includes a body having an upper portion with aperture 1610 and a lower portion with aperture 1612. Upper aperture 1610 connects drive assembly mount 124 to link 114. Lower aperture 1612 connects drive assembly mount 124 to link 116. Drive assembly mount 124 also includes support 1608 for supporting and positioning the motor and gearbox combination within space 1602 of drive assembly mount 124. Apertures 1614, 1616, 1618, and 1620 are provided for fastening the motor and gearbox combination (and optional sub-mounts 1220 and 1222) to drive assembly mount 124. Drive assembly mount 124 also includes protective walls 1604 and 1606 that protect the motor and gearbox combination from direct impacts by foreign objects, terrain and/or obstacles.

FIGS. 15 and 17 illustrate optional sub-mounts 1220 and 1222. These sub-mounts include spaces or recesses 1706 and 1706 to allow drive components such as a drive shaft to extend from the motor and gearbox combination to a drive wheel. So arranged, sub-mounts 1220 and 1222 also provide lateral protection from impacts and foreign objects. Apertures 1700 and 1702 are used to fasten sub-mount 1220 to drive assembly mount 124. Sub-mount 1222 can also be joined to drive assembly mount 124 via welding or formed integral therewith to provide a strong connection or integral body connection.

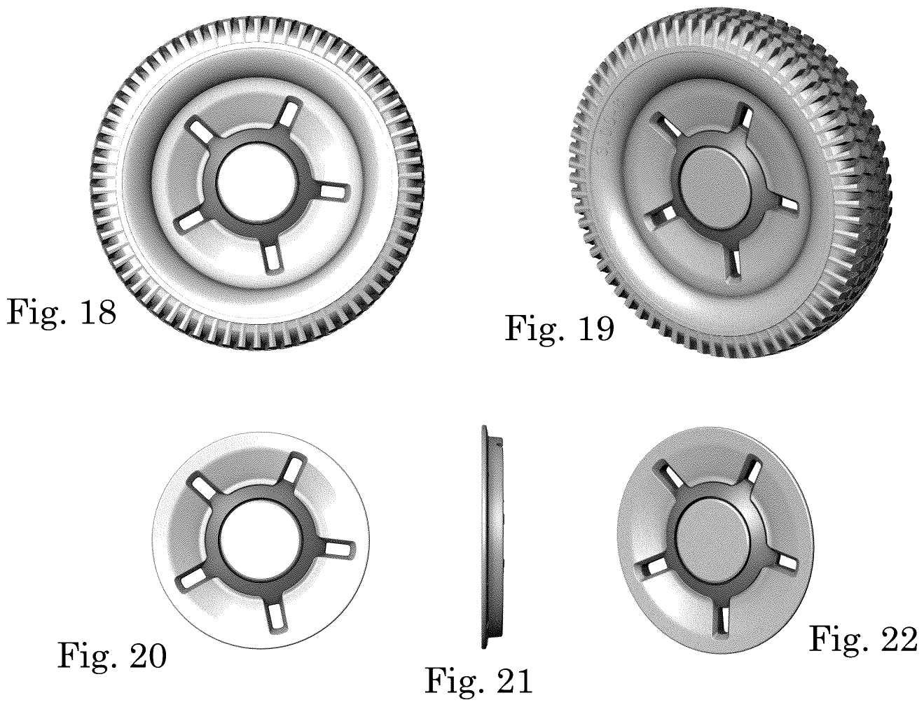

FIGS. 18 and 19 illustrate a design for one embodiment of a hub for a wheel including, for example, drive wheel 136. FIGS. 20-22 illustrate the design for one embodiment of just the hub without the wheel. While the entire hub design has been shown, other components can stand alone as designs including the five-point (or star or spoke) pattern originating from the central circular area of the hub.

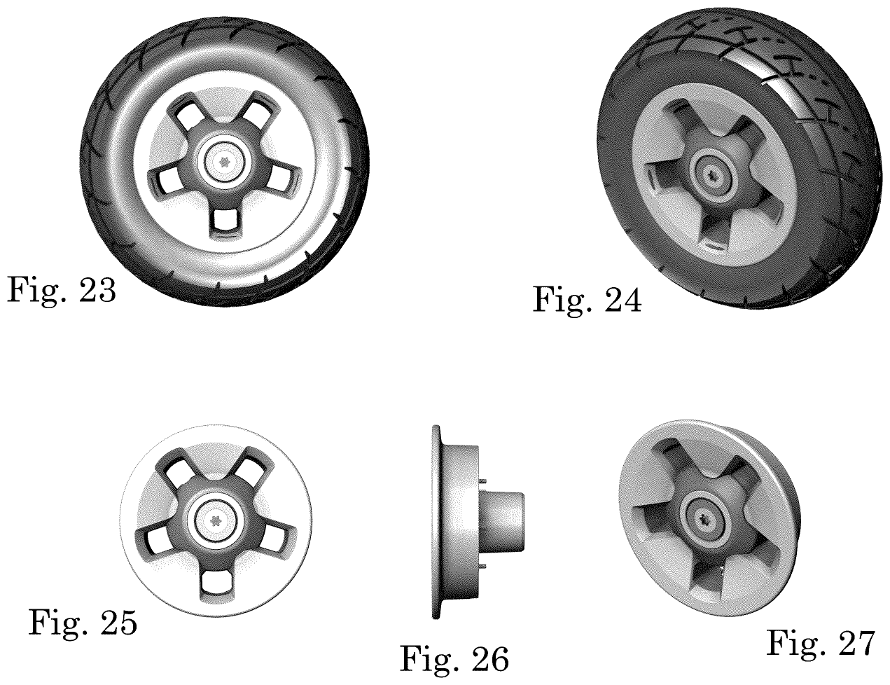

FIGS. 23 and 24 illustrate a design for another embodiment of a hub for a wheel including, for example, rear castor wheels 134. FIGS. 25-27 illustrate the design for one embodiment of just this hub without the wheel. While the entire hub design has been shown, other components can stand alone as designs including the five-point (or star or spoke) pattern originating from the central circular area of the hub.

In the ornamental embodiments of FIGS. 18-27, the surface topologies (e.g., convex, concave, combinations thereof, etc.) of the designs can be varied and are not critical to the illustrated ornamentality, nor are the relative proportions of the respective design features and components. Other ornamental design embodiments including varying design component size and proportions are within the scope of the disclosure herein.

While the present inventions and designs have been illustrated by the description of embodiments thereof, and while the embodiments have been described in considerable detail, it is not the intention of the descriptions to restrict or in any way limit the scope of the appended claims to such detail. Additional advantages and modifications will readily appear to those skilled in the art. Therefore, the inventions and designs, in broader aspects, are not limited to the specific details, the representative apparatus, and illustrative examples shown and described. Accordingly, departures can be made from such details without departing from the spirit or scope of the general inventive concepts.

1. A wheelchair comprising:
a base frame having an upper pivot connection and a lower pivot connection;
a drive assembly having first and second pivot connections;
a plurality of links connecting the drive assembly to the base frame, the plurality of links including:
a first pivoting link connecting the drive assembly first pivot connection to the base frame upper pivot connection;
a second pivoting link connecting the drive assembly second pivot connection to the base frame lower pivot connection; and
wherein the second pivoting link comprises a body that extends rearwardly of the drive assembly and connects to a rear caster wheel.

2. The wheelchair of claim 1 wherein the first link comprises a body having first and second end portions and a resilient member between the first and second end portions.

3. The wheelchair of claim 2 wherein the second end portion of the first link body is connected to the base frame upper pivot connection.

4. The wheelchair of claim 1 wherein the first link comprises a body having a shock absorber.

5. The wheelchair of claim 1 wherein the first link comprises a body having a resilient member.

6. The wheelchair of claim 1 wherein the first link comprises a body having a spring and shock absorber.

7. The wheelchair of claim 1 wherein the body of the second link comprises first and second end portions and wherein the first end portion is connected to the drive assembly second pivot connection.

8. The wheelchair of claim 1 wherein the body of the second link comprises first and second end portions and wherein the second end portion connects to the rear caster wheel.

9. The wheelchair of claim 1 wherein the drive assembly comprises a body having upper and lower portions and wherein the upper portion is connected to the first pivoting link.

10. The wheelchair of claim 1 wherein the drive assembly comprises a body having upper and lower portions and wherein the lower portion is connected to the second pivoting link.

11. The wheelchair of claim 1 wherein the drive assembly comprises a body having upper and lower portions and wherein the upper portion is connected to the first pivoting link and the lower portion is connected to the second pivoting link.

12. The wheelchair of claim 1 wherein the body of the second pivoting link extends rearwardly of the base frame.

13. The wheelchair of claim 1 wherein the body of the second pivoting link comprises a first portion and a second portion and wherein the second portion is angled with respect to the first portion and extends toward the rear caster wheel.

14. The wheelchair of claim 1 wherein the body of the second pivoting link comprises first, second and third portions, and wherein the first portion connects to the drive assembly, the second portion connects to the base frame lower pivot connection, and the third portion connects to the rear caster wheel.

15. The wheelchair of claim 1 wherein the drive assembly comprises a mounting body having upper and lower portions and wherein the upper portion comprise the drive assembly first pivot connection and the lower portion comprises the drive assembly second pivot connection.

16. A wheelchair comprising:
a base frame having an upper pivot connection and a lower pivot connection;
a drive assembly having first and second pivot connections, the first pivot connection connected to the base frame upper pivot connection;
a pivot arm connected to the base frame lower pivot connection and the drive assembly second pivot connection; and
wherein a first distance between the base frame upper pivot connection and the drive assembly first pivot connection is greater than a second distance between the base frame lower pivot connection and the drive assembly second pivot connection.

17. The wheelchair of claim 16 wherein the first distance comprises a varying length based on a shock force applied to the drive assembly.

18. The wheelchair of claim 16 wherein the first distance comprises a retracted length upon application of a shock force.

19. A wheelchair comprising:
a base frame having an upper pivot axis and a lower pivot axis;
a pivot arm connected to the base frame lower pivot axis;
a drive assembly connected to the base frame upper pivot axis by a link and connected to the pivot arm, wherein the drive assembly pivots about the pivot arm connection and pivots about the base frame upper pivot axis via the link; and
wherein the link is extendable and retractable.

20. The wheelchair of claim 19 wherein the link comprises a resilient member.
